(19) United States
(12) Patent Application Publication
(10) Pub. No.: US 2008/0285106 A1
(43) Pub. Date: Nov. 20, 2008

(54) Apparatus and Method For Nanoradian Metrology of Changes In Angular Orientation of A Vibrating Mirror Using Multi-Pass Optical Systems

(75) Inventor: Henry A. Hill, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/121,138

(22) Filed: May 15, 2008

Related U.S. Application Data
(60) Provisional application No. 60/939,022, filed on May 18, 2007.

(51) Int. Cl. G02B 26/08

(52) U.S. Cl. 359/213

(57) ABSTRACT

A new and useful metrology system is provided, of a type that comprises an optical cavity of the hemispherical or spherical type, with a vibrating mirror not located at or near a focus of the optical cavity, and which is particularly useful as a non interferometric metrology system. In one of its basic aspects, the metrology system measures changes in orientation of a vibrating mirror, by providing an optical cavity that includes reflection of a measurement beam from the vibrating mirror, where the optical cavity is configured such that an object space that includes the vibrating mirror is a conjugate image of the same object space. In another of its basic aspects, a metrology system according to the present invention has a measurement beam that is reflected from the vibrating mirror, where the vibrating mirror and a reference mirror are in a relationship in which reflection of the measurement beam from the vibrating mirror is then reflected from the reference mirror in a manner that establishes a local reference system for measuring changes in the orientation of the vibrating mirror.

### RELATED APPLICATION/CLAIM OF PRIORITY

This application is related to and claims priority from U.S. Provisional Application Ser. No. 60/939,022, filed May 18, 2007, and entitled Apparatus And Method For Nanoradian Metrology Of Changes In Angular Orientation Of A Vibrating Mirror Using Multi-Pass Optical Systems For Increased Angular Sensitivity, which provisional application is incorporated by reference herein.

### BACKGROUND

A class of interferometric metrology systems may be used to measure changes in orientation of a vibrating mirror with amplification of angular sensitivity by an optical cavity in a measurement leg of an interferometer. Examples of the optical cavity are a symmetric Fabry-Perot cavity and an asymmetric Fabry-Perot cavity such as the Gires-Tournois etalon [for a description of the Gires-Tournois etalon, reference is made to Section 8.2.2 entitled “Phase Modulation” of the book Optical Waves In Crystals by A. Yariv and P. Yeh, Wiley (1948)]. An interferometer comprising a beam shear between the reference and measurement beam paths may also be used to measure changes in orientation of a vibrating mirror with amplification of angular sensitivity wherein the beam shear is introduced as a result of a change in the direction of propagation of the beam. Amplification of sensitivity may be achieved in the class of interferometric metrology systems using multiple passes of a measurement beam to the vibrating mirror.

A class of non-interferometric metrology systems may be used to measure changes in angular orientation of a vibrating mirror with amplification of angular sensitivity based on non-interferometric techniques and use of an optical cavity configuration. A first subclass of the non-interferometric metrology systems that may be used to measure changes in angular orientation of a vibrating mirror with amplification of angular sensitivity is based on the location of the vibrating mirror at or near an internal focus of a measurement beam in the optical cavity with a confocal or semi-confocal configuration such as described in an article by Leo Beiser entitled “Near-Confocal Optical Scan Amplifier,” J. Appl. Phys., 43, pp. 3507-10 (1972). In the first subclass of the non-interferometric metrology systems, the respective dimension of a spot of the optical measurement beam on the vibrating mirror is determined by properties of the optical cavity and of an optical input beam wherein in general the respective dimension of the spot is less than a corresponding cross-sectional dimension of the vibrating mirror, e.g., less by a factor of 10 or a factor of 30.

Beiser (ibid.) considered near-confocal cavities formed by two concave mirrors with radii of curvature R₁ and R_{2,} respectively, where R₁=R₂≅d and d is the spatial separation of the two concave mirrors. For a description of properties of optical cavities, reference is made to Section 11.4 entitled “Laser Properties Associated With Optical Cavities Or Resonators” of Handbook of Optics I, Fundamentals, Techniques, & Design, 2^{nd} Ed., McGraw-Hill (1995).

In discussing the properties of the first subclass of non-interferometric metrology systems, it is of value to recognize that the maximum resolution that is obtainable for a change in angular orientation of a measurement object is proportional to the ratio of a respective dimension of a spot formed by the optical measurement beam on the vibrating mirror and the wavelength λ of the optical measurement beam. As a result, the angular resolution obtained with the first subclass of non-interferometric metrology systems is less, e.g. less by a factor of 10 or a factor of 30, than that obtainable in principle in other metrology systems wherein the spot size is limited by the corresponding dimension of the vibrating mirror.

A second subclass of non-interferometric metrology systems that may be used to measure changes in angular orientation of a vibrating mirror with amplification of angular sensitivity are described herein that does not exhibit the limitations of achievable resolutions of the first subclass of non-interferometric metrology systems. The second subclass of non-interferometric metrology systems comprise an optical cavity configuration of the hemispherical or spherical configuration type with the vibrating mirror not located at or near a focus of the optical cavity.

### SUMMARY OF THE PRESENT INVENTION

The present invention relates to a new and useful metrology system, and is particularly useful as a non interferometric metrology system of a type comprising an optical cavity configuration of the hemispherical or spherical configuration type with the vibrating mirror not located at or near a focus of the optical cavity.

In one of its basic aspects, the metrology system measures changes in orientation of a vibrating mirror, by providing an optical cavity that includes reflection of a measurement beam from the vibrating mirror, where the optical cavity is configured such that an object space that includes the vibrating mirror is a conjugate image of the same object space. Thus, in accordance with the principles of the present invention, the second subclass of non-interferometric metrology systems (described above) may be used to measure changes in angular orientation of a vibrating mirror with amplification of angular sensitivity wherein an object space of the non-interferometric metrology system that comprises a vibrating mirror is a conjugate image of the object space.

In another of its basic aspects, a metrology system according to the present invention has a measurement beam that is reflected from the vibrating mirror, where the vibrating mirror and a reference mirror are in a relationship in which reflection of the measurement beam from the vibrating mirror is then reflected from the reference mirror in a manner that establishes a local reference system for measuring changes in the orientation of the vibrating mirror.

In yet another of its basic aspects, a metrology system according to the present invention provides (a) an optical cavity in which a pair of measurement beams are reflected from the vibrating mirror and imaged at an image plane during each of a plurality of passes of the measurement beams through a portion of the optical cavity, (b) the optical cavity including a vibrating mirror subsystem in which the pair of measurement beams are reflected from the vibrating mirror and from a reference mirror during each of a plurality of passes of the measurement beams through a portion of the optical cavity, and (c) wherein the vibrating mirror subsystem and the paths of the measurement beams directed into and out of the vibrating mirror subsystem are configured to reduce the influence of air turbulence on the measurement beams in at least one predetermined reference plane.

In still another of its basic aspects, a metrology system according to the present invention provides (a) an optical cavity in which a pair of measurement beams are (i) reflected from the vibrating mirror and from a reference mirror and (ii) imaged at an image plane, during each of a plurality of passes of the measurement beams through a portion of the optical cavity, and (b) an input beam subsystem comprising an input beam source that produces a single input beam and an input beam conditioner that (i) produces a pair of measuring beams from the single input beam, (ii) focuses the pair of measurement beam as spots on a first plane and (iii) directs the pair of measurement beams into the portion of the optical cavity; and (c) wherein the portion of the optical cavity and the input beam conditioner are configured such that the common mode component of the locations of the focused spots on the first plane is invariant to displacements and/or changes in the orientation of either the input beam conditioner or the input beam subsystem, and the differential mode component of the locations of the corresponding focused spots on the image plane is not invariant and is sensitive to displacements and/or changes in orientation and/or location of either the input beam conditional or the input beam subsystem.

One specific objective of the system of the present invention is to provide a metrology system that will monitor changes in the mean angular position and the amplitude of vibration of a mirror at less than the 10 nanorad/day and 600 nanorad/day, respectively.

These and other features of the present invention will become apparent from the following detailed description and the accompanying drawings.

### BRIEF DESCRIPTION OF THE DRAWINGS

FIG. 1a is a schematic, planar illustration of a metrology system, according to the principles of the present invention;

FIG. 1b is a schematic, planar illustration of a portion of the metrology system of FIG. 1a;

FIG. 2 is a schematic, three dimensional illustration of the metrology system of FIGS. 1a and 1b;

FIG. 3 is a schematic, three dimensional illustration of the vibrating mirror subsystem, in the metrology system of FIG. 2; and

FIG. 4 is a schematic, three dimensional illustration of a portion of the input beam conditioner, in the metrology system of FIG. 2.

### DETAILED DESCRIPTION

As described above, a metrology system according to the principles of the present invention is particularly useful in connection with a subclass of metrology systems that comprise an optical cavity of the hemispherical or spherical type, with the vibrating mirror not located at or near a focus of the optical cavity. The principles of the present invention are specifically described herein in connection with such a subclass of metrology systems, and from that description the manner in which the principles of the present invention can be applied to various types of metrology systems will be apparent to those in the art.

Inintiall, it is believed useful to note that the following detailed description and accompanying drawings describe a preferred version of a metrology system, of the subclass of metrology systems described above, and according to the principles of the present invention, in which
a. nanoradian non-interferometric metrology systems for measuring and monitoring changes in angular orientation of a vibrating mirror are provided which provide enhancements of angular deflection of an optical beam or of a displacement of an optical beam focus wherein the optical beam is reflected by the vibrating mirror (e.g. vibrating mirror 30 in the Figures). The non-interferometric metrology systems relate to measurement of changes in orientation of objects such as used in the manufacture of integrated circuits.
b. The enhancements of the angular deflection or of the displacement of the beam focus are proportional to the number of times that the optical beam is incident on the vibrating mirror 30. With the subclass of non-interferometric metrology systems comprising optical cavity configurations of the hemispherical or spherical type, an object space thereof that comprises the vibrating mirror 30 is a conjugate image of the same object space. The maximum sensitivity of the non-interferometric metrology systems for detection of the changes in angular orientation of the vibrating mirror 30 about an axis is further proportional to the dimension of the vibrating mirror perpendicular to the axis. The changes in angular orientation of the vibrating mirror 30 are detected as changes with respect to a local reference system that is defined by the vibrating mirror 30 and at least one other mirror (i.e. reference mirror 32) that together exhibit transformation properties of a Porro prism or a retroreflector.
c. Measured changes in the angular orientation of the vibrating mirror by the second subclass of non-interferometric metrology systems are invariant in other degrees of freedom, e.g. linear and angular displacements and temperature changes, of subsystems of the subclass of non-interferometric metrology systems. Environmental and turbulence effects of a gas in the paths of optical beams used in the subclass of non-interferometric metrology systems on the angular deflection of the optical beam or on the displacement of the beam focus are compensated to first order spatial derivatives of the environmental and turbulence effects in certain of the second subclass of non-interferometric metrology systems and to second order spatial derivatives in certain other of the subclass of non-interferometric metrology systems.
d. The use of a subclass non-interferometric metrology system wherein an object space of the second subclass non-interferometric metrology system comprising the vibrating mirror 30 as a conjugate image of the object space, i.e., a self conjugate imaging property, eliminates or significantly reduces beam shear at the vibrating mirror resulting from a change in angular orientation of the vibrating mirror. Beam shear effects can limit the number of passes to the vibrating mirror that can be effectively used in a metrology system which does not exhibit the self conjugate imaging property.
e. Examples of the subclass of non-interferometric metrology systems are described herein that are functionally equivalent to a ring cavity and a plane parallel cavity (R₁=R₂=∞). The examples comprise afocal optical systems with angular magnification equal to −1.0 and 1.0, respectively, which enable the self conjugate imaging property wherein an object space of the non-interferometric metrology system comprising the vibrating mirror is a conjugate image of the object space.
f. The changes in orientation of the vibrating mirror are detected as changes with respect to a local reference system that is defined by the vibrating mirror and at least one other mirror that together exhibit transformation properties of a Porro prism in a plane or a retroreflector in three dimensions.
g. Measured changes in the angular orientation of the vibrating mirror by a metrology system of the non-interferometric metrology systems are invariant in other degrees of freedom, e.g. linear and angular displacements and temperature changes, of subsystems of the metrology system. Environmental and turbulence effects of a gas in the paths of optical beams used in the non-interferometric metrology systems on the angular deflection of respective optical beams or on the displacements of the focus of the optical beams are compensated to first order spatial derivatives of the environmental and turbulence effects in certain of the non-interferometric metrology systems and to second order spatial derivatives in certain other of the non-interferometric metrology systems.

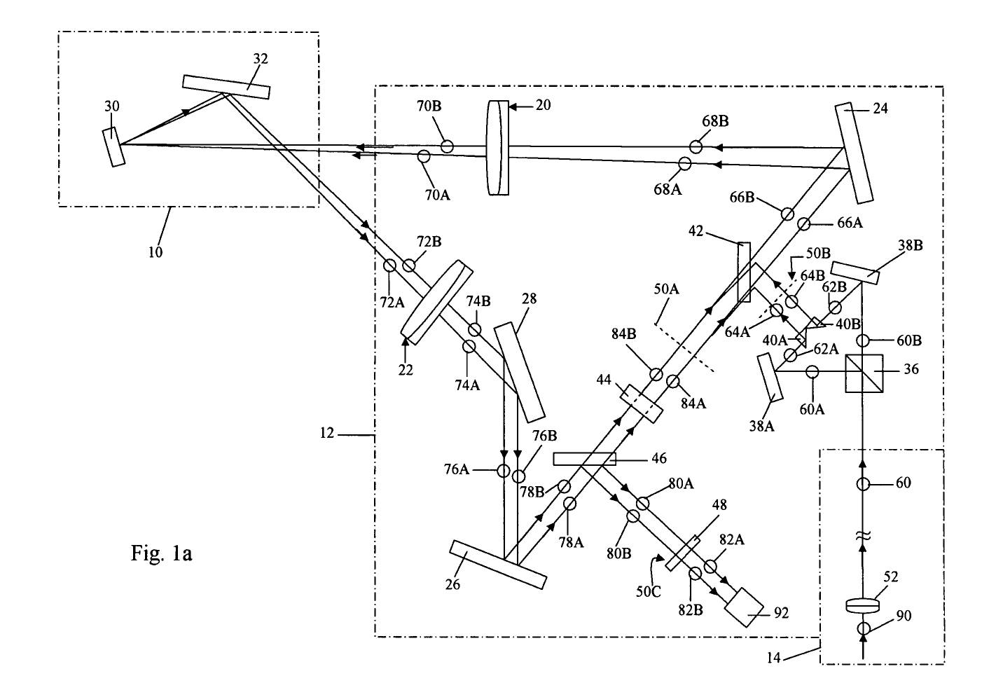

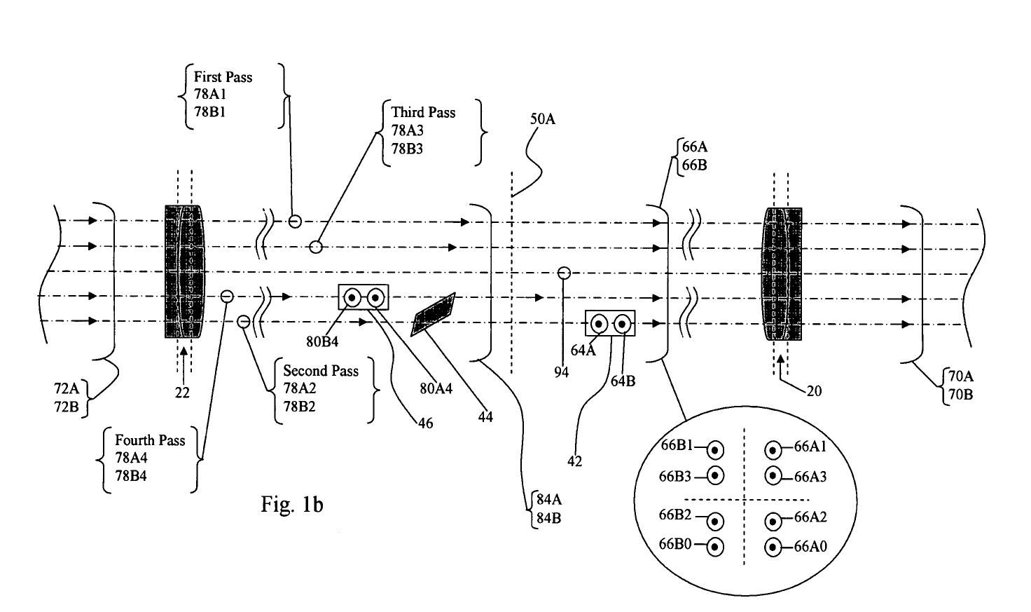

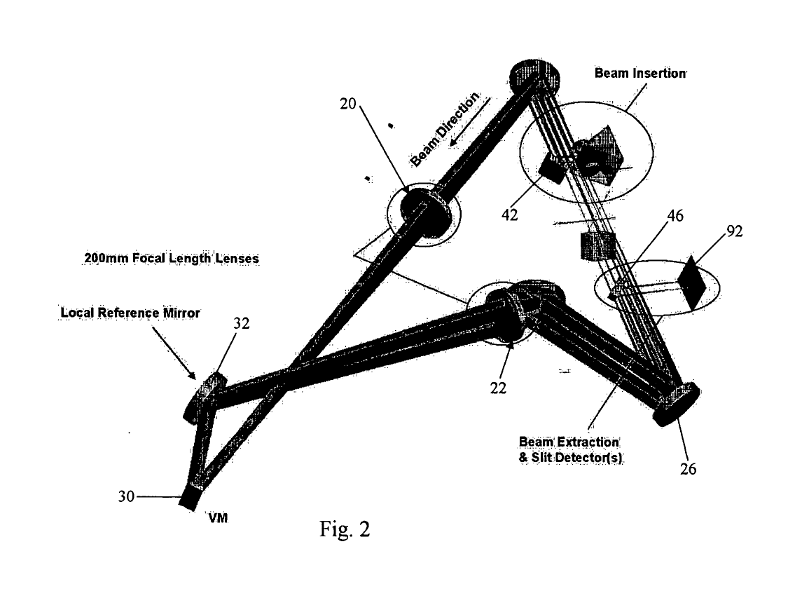

The first of the two examples of the subclass of non-interferometric metrology systems is shown schematically in FIG. 1a (and FIG. 2) and configured as a ring (optical) cavity that comprises three subsystems 10, 12, and 14. Subsystem 10 comprises vibrating mirror 30 and reference mirror 32 which together exhibit the transformation properties of Porro prism and establish a reference system in which changes in the orientation of vibrating mirror 30 are measured. Subsystem 12 comprises an afocal optical system configured with angle magnification equal to −1.0 and with transformation properties corresponding to the retroreflector such as described in U.S. Pat. No. 6,198,574 B1 entitled “Polarization Preserving Optical Systems” by Henry A. Hill, and which is incorporated by reference herein. The afocal optical system with respect to transformation properties is also functionally equivalent to a Cat's eye retroreflector. For a description of a Cat's eye retroreflector and properties thereof, reference is made to an article by J. J. Snyder entitled “Paraxial Ray Analysis Of A Cat's-Eye Retroreflector,” Appl. Opt. 14, pp 1825-(1975). Subsystem 12 further comprises an input beam conditioning system wherein the input beam conditioner comprises beam-splitter 36, mirrors 38A and 38B, prisms 40A and 40B used as total internal reflectors, and plane 50B.

Input beam subsystem 14 comprises a collimated beam 90 from a source such as a laser (not shown in FIG. 1a or in FIG. 2) and lens 52. Beam 90 is incident on lens 52 and a portion thereof is transmitted as converging beam 60.

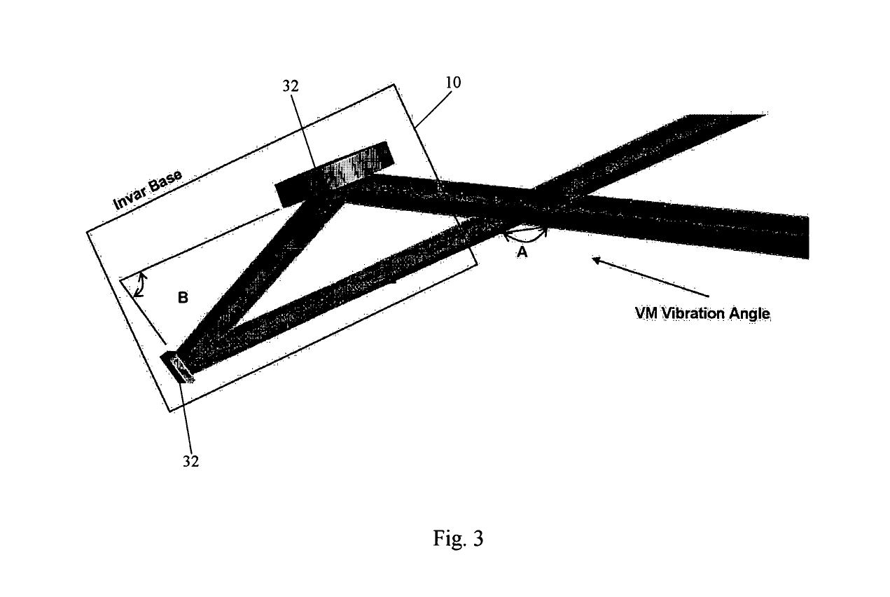

A reference coordinate system is based on a single local reference mirror 32 (see FIG. 1a and FIG. 3) located near the vibrating mirror 30. Measured locations of focused beam spots formed by beams 80A and 80B at image plane 50C detected by detector 92 are proportional to (θ_{VM}−θ_{Ref}) where θ_{VM} and θ_{Ref} represent changes in the orientation of mirrors 30 and 32, respectively. Also, it should be noted that the angle A between the input to and output from the vibrating mirror subsystem 10 is equal to twice the angle B between the mirrors 30, 32 (see FIG. 3). Therefore, spot shift at the detector (i.e. 92 in FIG. 1a) is insensitive to motions of the two mirrors as they drift together. Moreover, because the measurement beams flip about the vertical direction, the deflection is insensitive to refractive index gradients in the horizontal direction.

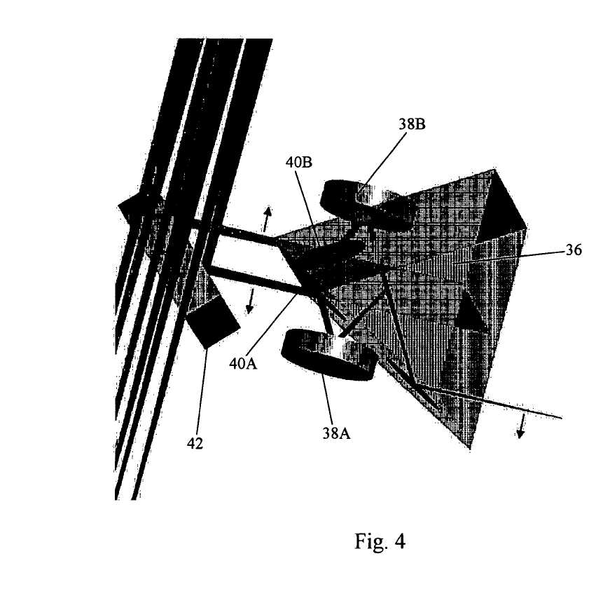

The input beam conditioner 14 (FIG. 1a, FIG. 4) is configured to generate two beams from a single input beam. Converging input beam 60 is incident on beam-splitter 36 and first and second portions thereof are reflected and transmitted, respectively, as converging beams 60A and 60B, respectively. Converging beams 60A and 60B are reflected by mirrors 38A and 38B, respectively, as converging beams 62A and 62B, respectively, which are in turn reflected by total internal reflectors 40A and 40B, respectively, as converging beams 64A and 64B, respectively. Converging beams 64A and 64B converge to two corresponding focused spots on plane 50B.

An important invariance property of the input beam conditioner which comprises plane 50B is that the common mode component of the locations of the two corresponding focused spots on plane 50B is invariant to displacements and/or changes in orientation of either the input beam conditioner or of subsystem 14 comprising converging input beam 60. However, the differential mode component of the locations of the two corresponding focused spots on plane 50B is not invariant and is sensitive to displacements and/or changes in orientation and/or location of either the input beam conditioner or of subsystem 14.

As a result of the afocal optical system being of the general retroreflector class (U.S. Pat. No. 6,198,574 B1, incorporated by reference, ibid.) with respect to transformation properties of beam directions and wavefront orientations and as a result of the invariance property of the input beam conditioning system, a change in position and/or orientation of the afocal optical system and the input beam conditioner as a single unit does not change the common mode component or the average value of (θ_{VM}−θ_{Ref}) in yaw (yaw is measured in the plane parallel to the plane of FIG. 1a) obtained from output focused spot locations of beams 80A and 80B (see FIG. 1b) at image plane 50C.

The propagation of beams through subsystems 10 and 12 is next described with reference to FIGS. 1a and 1b. Converging input beams 64A and 64B form input diverging beam components 66A0 and 66B0, respectively, of diverging beams 66A and 66B, respectively, after passing through plane 50B and reflections by mirror 42. An exploded cross-section of diverging beams 66A and 66B is shown in FIG. 1b. The directions of propagation of input diverging beam components 66A0 and 66B0 are parallel to the optic axis 94 shown in FIG. 1b. Input diverging beam components 66A0 and 66B0 are reflected by mirror 24 as input diverging beam components of beams 68A and 68B, respectively, wherein input diverging beam components 68A0 and 68B0 are incident on lens 20 and transmitted as collimated input beam components of beams 70A and 70B, respectively.

Collimated input beam components of beams 70A and 70B are incident on subsystem 10 and emerge as collimated input beam components of beams 72A and 72B, respectively. In subsystem 10, collimated input beam components of beams 70A and 70B are reflected by vibrating mirror 30 and reference mirror 32. In addition, collimated input beam components of beams 70A and 70B are coextensive at vibrating mirror 30 and the size of coextensive collimated input beam components of beams 70A and 70B at vibrating mirror 30 is selected to be a predetermined fraction of the size of vibrating mirror 30 in the yaw plane. The predetermined fraction is determined taking into consideration that the sensitivity of the first example to detection of changes in orientation of vibrating mirror 30 is proportional to the value of the predetermined fraction and the magnitude of the surface figure errors of vibrating mirror 30.

Collimated input beam components of beams 72A and 72B are next incident on lens 22 and transmitted as converging first pass components of beams 74A and 74B, respectively. The directions of propagation of converging first pass components of beams 74A and 74B are parallel to optic axis 94 shown in FIG. 1b. The converging first pass components of beams 74A and 74B are reflected by mirror 28 as converging first pass components of beams 76A and 76B, respectively, and converging first pass components of beams 76A and 76B are reflected by mirror 26 as converging first pass components 78A1 and 78B1, respectively, of beams 78A and 78B, respectively (see FIG. 1b). Converging first pass components 78A1 and 78B1 form converging first pass components of beams 84A and 84B, respectively. Converging first pass components of beams 84A and 84B converge to form images on image plane 50A of the two corresponding focused spots on plane 50B. Converging first pass components of beams 84A and 84B form diverging first pass components 66A1 and 66B1, respectively, of beams 66A and 66B, respectively.

The description of the propagation of diverging first pass components 66A1 and 66B1 through subsystems 10 and 12 to form converging second pass components 78A2 and 78B2, respectively, of beams 78A and 78B, respectively, is the same as corresponding portions of the description given for the propagation of input diverging components 66A0 and 66B0 through subsystems 10 and 12 to form converging first pass components 78A1 and 78B1, respectively, of beams 78A and 78B wherein input is changed to first and first is changed to second. Converging second pass components 78A2 and 78B2 are incident on rhomb 44 (see FIG. 1b) and transmitted as converging second pass components of beams 84A and 84B, respectively. Converging second pass components of beams 84A and 84B are displaced in the vertical direction and converge to form images on image plane 50A of the two corresponding focused spots on plane 50B. Converging second pass components of beams 84A and 84B form diverging second pass components 66A2 and 66B2, respectively, of beams 66A and 66B, respectively (see FIG. 1b).

The description of the propagation of diverging second pass components 66A2 and 66B2 through subsystems 10 and 12 to form converging third pass components 78A3 and 78B3, respectively, of beams 78A and 78B, respectively, is the same as corresponding portions of the description given for the propagation of diverging first pass components 66A1 and 66B1 through subsystems 10 and 12 to form converging second pass components 78A2 and 78B2, respectively, of beams 78A and 78B, respectively, wherein first pass is changed to second pass and second pass is changed to third pass. Converging third pass components 78A3 and 78B3 form converging third pass components of beams 84A and 84B, respectively. Converging third pass components of beams 84A and 84B converge to form images on image plane 50A of the two corresponding focused spots on plane 50B. Converging third pass components of beams 84A and 84B form diverging third pass components 66A3 and 66B3, respectively, of beams 66A and 66B, respectively.

The description of the propagation of diverging third pass components 66A3 and 66B3 through subsystems 10 and 12 to form converging fourth pass components 78A4 and 78B4, respectively, of beams 78A and 78B, respectively, is the same as corresponding portions of the description given for the propagation of diverging second pass components 66A2 and 66B2 through subsystems 10 and 12 to form converging second pass components 78A3 and 78B3, respectively, of beams 78A and 78B wherein second pass is changed to third pass and third pass is changed to fourth pass.

Next in the description of beam propagation, converging fourth pass components 78A4 and 78B4 form converging fourth pass components of beams 80A and 80B, respectively, after reflections by mirror 46. Converging fourth pass components of beams 80A and 80B converge to form images on image plane 50C of the two corresponding focused spots on plane 50B. Image plane 50C corresponds to the surface of a linear array of transmitting and non-transmitting regions 48, e.g. a Ronchi type grating or ruling, to enable multiple slit/knife edge detector technology. Portions of the two images on image plane 50C are transmitted as spatially filtered beams 82A and 82B and detected by two detectors in detector 92 to generate two corresponding signals. The two corresponding signals are processed by an electronic processor (not shown in FIG. 1a) for the common mode component of the locations of the two images on image plane 50C and other properties of the motion of the common mode component of the locations, e.g. an amplitude of oscillation of the common mode component of the locations.

In other embodiments of the subclass of non-interferometric metrology systems in which an optical cavity configuration of the hemispherical or spherical configuration type with the vibrating mirror not located at or near a focus of the optical cavity, the linear array of transmitting and non-transmitting regions 48 can be removed and the sensitive surfaces of detectors in detector 92 relocated to coincide with image plane 50C wherein the detectors of detector 92 comprise two quad cell detectors without departing from the scope or spirit of the present invention.

Turbulence and environmental effects of air in the corresponding measurement paths of beams 70A and 72A and the corresponding measurement paths of beams 70B and 72B are compensated through second order spatial gradients of the turbulence and environmental effects in yaw as a result of subsystem 10 being configured to have the transformation properties of a Porro prism in the plane of FIG. 1a.

In other embodiments of the subclass of non-interferometric metrology systems in which an optical cavity configuration of the hemispherical or spherical configuration type with the vibrating mirror not located at or near a focus of the optical cavity, turbulence and environmental effects of air in the corresponding measurement paths of beams 70A and 72A and the corresponding measurement paths of beams 70B and 72B may be compensated through second order spatial gradients of the turbulence and environmental effects in both pitch and yaw without departing from the scope or spirit of the present invention by configuring subsystem 10 to exhibit the transformation properties of the general retroreflector (see U.S. Pat. No. 6,198,574 B1, incorporated by reference, ibid.), e.g. the placement of an image inverter in either the measurement paths of beams 70A and 72A or in the measurement paths of beams 70B and 72B.

Another example of the subclass of non-interferometric metrology systems in which an optical cavity configuration of the hemispherical or spherical configuration type with the vibrating mirror not located at or near a focus of the optical cavity can be obtained by arranging the orientation of vibrating mirror 30 such that a beam from lens 22 incident on vibrating mirror 30 is reflected back to lens 22, arranging the orientation of reference mirror 32 such that a beam from lens 20 incident on reference mirror 32 is reflected back to lens 20, and the elimination of mirror 28. All of the advantages listed for the subclass of non-interferometric metrology systems described above also apply to the this example except that each full pass of the system for this example requires two passes through the afocal subsystem in comparison to a single pass through the afocal subsystem of the example described above.

Thus, as seen from the foregoing discussion, in one of its basic aspects, the metrology system of the present invention measures changes in orientation of the vibrating mirror 30, by providing an optical cavity that includes reflection of a measurement beam from the vibrating mirror, where the optical cavity is configured such that an object space that includes the vibrating mirror (i.e. the vibrating mirror subsystem 10 and the image produced by reflection from the reference mirror 32) is a conjugate image of the same object space.

Moreover, it will be clear to those in the art that in another of its basic aspects, a metrology system according to the present invention has a measurement beam that is reflected from the vibrating mirror 30, where the vibrating mirror and the reference mirror 32 are in a relationship in which reflection of the measurement beam from the vibrating mirror is then reflected from the reference mirror in a manner that establishes a local reference system for measuring changes in the orientation of the vibrating mirror.

Still further, it will be clear that in yet another of its basic aspects, a metrology system according to the present invention provides (a) an optical cavity (10, 12) in which a pair of measurement beams are reflected from the vibrating mirror and imaged at an image plane (50A) during each of a plurality of passes of the measurement beams through a portion of the optical cavity, (b) the optical cavity including a vibrating mirror subsystem (10) in which the pair of measurement beams are reflected from the vibrating mirror (30) and from the reference mirror (32) during each of a plurality of passes of the measurement beams through a portion of the optical cavity, and (c) wherein the vibrating mirror subsystem (10) and the paths of the measurement beams directed into and out of the vibrating mirror subsystem are configured to reduce the influence of air turbulence on the measurement beams in at least one predetermined reference plane ( e.g. the plane of FIG. 1a).

In still another of its basic aspects, a metrology system according to the present invention provides (a) an optical cavity in which a pair of measurement beams are (i) reflected from the vibrating mirror (30) and from the reference mirror (32) and (ii) imaged at an image plane (50A), during each of a plurality of passes of the measurement beams through a portion of the optical cavity, and (b) an input beam subsystem (14) comprising an input beam source that produces a single input beam and an input beam conditioner (36, 38A, 38B, 40A, 40B) that (i) produces a pair of measuring beams (64A, 64B) from the single input beam, (ii) focuses the pair of measurement beam as spots on a first plane (50B) and (iii) directs the pair of measurement beams into the portion of the optical cavity; and (c) wherein the portion of the optical cavity and the input beam conditioner are configured such that the common mode component of the locations of the focused spots on the first plane is invariant to displacements and/or changes in the orientation of either the input beam conditioner or the input beam subsystem, and the differential mode component of the locations of the corresponding focused spots on the image plane (50A) is not invariant and is sensitive to displacements and/or changes in orientation and/or location of either the input beam conditioner or the input beam subsystem.

As described above, One specific objective of the system of the present invention is to provide a metrology system that will monitor changes in the mean angular position and the amplitude of vibration of a mirror at less than the 10 nanorad/day and 600 nanorad/day, respectively. Some specific advantages of a metrology system according to the present invention are as follows:
a. A local reference coordinate system is established for a measurement and/or monitoring changes in orientation of a vibrating mirror which is being measured and/or monitored.
b. Changes in location of an output beam from an optical system for magnification of effects of changes in direction of an optical beam at a detector is proportional to N times the change in orientation of a vibrating mirror in the local reference system.
c. Changes in location of an output beam at a detector from an optical system for magnification of effects of changes in orientation of a vibrating mirror is proportional to N times the change in orientation of a vibrating mirror in the local reference coordinate system, e.g. N=4, 6, 8.
d. Changes in location of an output beam at a detector from an optical system for magnification of effects of changes in orientation of a vibrating mirror is proportional to N times the difference in changes orientation of a vibrating mirror relative to changes in orientation of a fixed reference mirror, e.g. N =3, 6, 9.
e. Location of an output beam at a detector from an optical system for magnification of effects of changes in orientation of a vibrating mirror is independent to first order of changes in orientation and displacement of the optical system.
f. Location of an output beam at a detector from an optical system for magnification of effects of changes in orientation of a vibrating mirror is independent to first order of displacements of the vibrating mirror in a direction perpendicular to the reflecting surface of the vibrating mirror.
g. Location of an output beam at a detector from an optical system for magnification of effects of changes in orientation of a vibrating mirror is independent to first order of uniform changes in temperature of the optical system.
h. The optical system for magnification of effects of changes in orientation of a vibrating mirror is polarization preserving for two polarization eigenmodes (the use of the optical system in products would not infringe on cited prior art).
i. The optical system for magnification of effects of changes in orientation of a vibrating mirror is not sensitive to first order spatial derivative of the refractivity of a gas in the region between the optical system and the vibrating mirror and reference mirror.
j. The optical system for magnification of effects of changes in orientation of a vibrating mirror is not sensitive to first and second order spatial derivatives of the refractivity of a gas in the region between the optical system and the vibrating mirror and reference mirror.
k. The optical system for magnification of effects of changes in orientation of a vibrating mirror is configured such that the output of the optical system is not sensitive to changes in direction of the respective input beam to the optical system.
l. The optical system for magnification of effects of changes in orientation of a vibrating mirror is configured such that the output of the optical system is not sensitive to changes in amplitude profile of the respective input beam to the optical system.

With the foregoing disclosure in mind, the manner in which the principles of the present invention can be used to produce a new and useful metrology system metrology of a type that comprises an optical cavity of the hemispherical or spherical type, with a vibrating mirror not located at or near a focus of the optical cavity, and which is particularly useful as a non interferometric metrology system, will be apparent to those in the art.

1. A metrology system for measuring changes in orientation of a vibrating mirror, comprising an optical cavity that includes reflection of a measurement beam from the vibrating mirror, the optical cavity configured such that an object space that includes the vibrating mirror is a conjugate image of the same object space.

2. A metrology system as defined in claim 1, wherein the object space of the optical cavity includes a reference mirror in a predetermined relation to the vibrating mirror such that reflection of a measurement beam from the vibrating mirror is further reflected from the reference mirror.

3. A metrology system as defined in claim 2, wherein reflection of the measurement beam from the vibrating mirror and the further reflection of the measurement beam from the reference mirror establishes a local reference system for measuring changes in the orientation of the vibrating mirror.

4. A metrology system as defined in claim 2, wherein the relation of the reference mirror and the vibrating mirror is configured to provide the transformation properties of a Porro prism.

5. A metrology system as defined in claim 4, wherein the optical cavity is configured such that the measurement beam is transmitted along a plurality of passes through the optical cavity, each pass including reflection from the vibrating mirror and the reference mirror.

6. A metrology system as defined in claim 2, wherein
a. a pair of measurement beams are reflected from the vibrating mirror and imaged at an image plane during each of a plurality of passes of the measurement beams through a portion of the optical cavity, and
b. the vibrating mirror and reference mirror form a vibrating mirror subsystem in which the pair of measurement beams are reflected from the vibrating mirror and from the reference mirror during each of a plurality of passes of the measurement beams through a portion of the optical cavity; and wherein
c. the vibrating mirror subsystem and the paths of the measurement beams directed into and out of the vibrating mirror subsystem are configured to reduce the influence of air turbulence on the measurement beams in at least one predetermined reference plane.

7. A metrology system as defined in claim 2, wherein
a. a pair of measurement beams are (i) reflected from the vibrating mirror and from the reference mirror and (ii) imaged at an image plane, during each of a plurality of passes of the measurement beams through a portion of the optical cavity, and
b. an input beam subsystem comprises an input beam source that produces a single input beam and an input beam conditioner that (i) produces a pair of measuring beams from the single input beam, (ii) focuses the pair of measurement beams as spots on a first plane and (iii) directs the pair of measurement beams into the portion of the optical cavity; and wherein
c. the portion of the optical cavity and the input beam conditioner are configured such that the common mode component of the locations of the focused spots on the first plane is invariant to displacements and/or changes in the orientation of either the input beam conditioner or the input beam subsystem, and the differential mode component of the locations of the corresponding focused spots on the image plane is not invariant and is sensitive to displacements and/or changes in orientation and/or location of either the input beam conditioner or the input beam subsystem.

8. A metrology system for measuring changes in the orientation of a vibrating mirror, comprising an optical cavity in which a measurement beam is reflected from the vibrating mirror, and wherein the vibrating mirror and a reference mirror are in a relationship in which reflection of the measurement beam from the vibrating mirror is then reflected from the reference mirror in a manner that establishes a local reference system for measuring changes in the orientation of the vibrating mirror.

9. A metrology system as defined in claim 8, wherein
a. a pair of measurement beams are reflected from the vibrating mirror and imaged at an image plane during each of a plurality of passes of the measurement beams through a portion of the optical cavity, and
b. the vibrating mirror and reference mirror form a vibrating mirror subsystem in which the pair of measurement beams are reflected from the vibrating mirror and from the reference mirror during each of a plurality of passes of the measurement beams through a portion of the optical cavity; and wherein
c. the vibrating mirror subsystem and the paths of the measurement beams directed into and out of the vibrating mirror subsystem are configured to reduce the influence of air turbulence on the measurement beams in at least one predetermined reference plane.

10. A metrology system as defined in claim 8, wherein
a. a pair of measurement beams are (i) reflected from the vibrating mirror and from the reference mirror and (ii) imaged at an image plane, during each of a plurality of passes of the measurement beams through a portion of the optical cavity, and
b. an input beam subsystem comprises an input beam source that produces a single input beam and an input beam conditioner that (i) produces a pair of measuring beams from the single input beam, (ii) focuses the pair of measurement beam as spots on a first plane and (iii) directs the pair of measurement beams into the portion of the optical cavity; and wherein
c. the portion of the optical cavity and the input beam conditioner are configured such that the common mode component of the locations of the focused spots on the first plane is invariant to displacements and/or changes in the orientation of either the input beam conditioner or the input beam subsystem, and the differential mode component of the locations of the corresponding focused spots on the image plane is not invariant and is sensitive to displacements and/or changes in orientation and/or location of either the input beam conditioner or the input beam subsystem.

11. A metrology system for measuring changes in the orientation of a vibrating mirror, comprising
a. an optical cavity in which a pair of measurement beams are reflected from the vibrating mirror and imaged at an image plane during each of a plurality of passes of the measurement beams through a portion of the optical cavity,
b. the optical cavity including a vibrating mirror subsystem in which the pair of measurement beams are reflected from the vibrating mirror and from a reference mirror during each of a plurality of passes of the measurement beams through a portion of the optical cavity, and
c. wherein the vibrating mirror subsystem and the paths of the measurement beams directed into and out of the vibrating mirror subsystem are configured to reduce the influence of air turbulence on the measurement beams in at least one predetermined reference plane.

12. A metrology system for measuring changes in the orientation of a vibrating mirror, comprising
a. an optical cavity in which a pair of measurement beams are (i) reflected from the vibrating mirror and from a reference mirror and (ii) imaged at an image plane, during each of a plurality of passes of the measurement beams through a portion of the optical cavity, and
b. an input beam subsystem comprising an input beam source that produces a single input beam and an input beam conditioner that (i) produces a pair of measuring beams from the single input beam, (ii) focuses the pair of measurement beams as spots on a first plane and (iii) directs the pair of measurement beams into the portion of the optical cavity; and
c. wherein the portion of the optical cavity and the input beam conditioner are configured such that the common mode component of the locations of the focused spots on the first plane is invariant to displacements and/or changes in the orientation of either the input beam conditioner or the input beam subsystem, and the differential mode component of the locations of the corresponding focused spots on the image plane is not invariant and is sensitive to displacements and/or changes in orientation and/or location of either the input beam conditional or the input beam subsystem.
